(19) United States
(12) Patent Application Publication
(10) Pub. No.: US 2014/0172611 A1
(43) Pub. Date: Jun. 19, 2014

(54) BUYER-SOLICITED OFFERINGS

(71) Applicants: Amrita Kaushik, Pin (IN); Savtanter Gadoo, Pin (IN)

(72) Inventors: Amrita Kaushik, Pin (IN); Savtanter Gadoo, Pin (IN)

(73) Assignee: eBay Inc., San Jose, CA (US)

(21) Appl. No.: 13/714,120

(22) Filed: Dec. 13, 2012

(51) Int. Cl. G06Q 30/06

(52) U.S. Cl. CPC G06Q 30/0605
USPC 705/26.2

(57) ABSTRACT

Members of a buyers' group hosted at an online marketplace submit desired-item descriptions for items the desired purchase. The desired-item descriptions are developed into desired-item listings presented at the buyers' group. Multiple buyers may be interested in the same desired-item listing and having expressed a purchase commitment for the item listing, their cumulative numbers as potential buyers may be displayed to sellers navigating the marketplace. A seller having a corresponding sale item to the desired-item may submit an item description that is developed into an item listing and containing an offer to sell the item. In this way buyers are able to attract offers to sell items that the buyers desire and by attracting multiple sellers, bidding wars between sellers develop higher value deals for the buyers.

### TECHNICAL FIELD

This patent document pertains generally to online marketplaces, and more particularly, but not by way of limitation, to buyer-solicited offerings.

### BACKGROUND

Users of online ecommerce sites may typically find that their shopping experience is limited to the offerings that sellers present to shoppers navigating the site. A shopper at a particular ecommerce site typically finds that they are limited to sellers' offerings of items that may differ significantly from the items they desire to purchase. The offerings available to the shopper are limited to what a particular set of sellers present at a given ecommerce site at a given time. The offerings presented to the shopper have the particular item and price that the seller desires to place in the item listing. The seller may have other similar items that they generally want to sell but do not recognize that a particular demand for those items exists at the site. The shopper may desire one of the other similar items but not be able to purchase it if the seller does not present it as an offering for sale at the ecommerce site.

The seller may or may not pay any attention to the offerings presented at the ecommerce site by other sellers, let alone may be offered by further sellers at other ecommerce sites. Because attentiveness to other sellers is a seller-initiated interest, the incentive of the seller to offer a lower price, a particular item, or particular item configuration is not a motivation. The shopper's shopping experience may be significantly limited accordingly, and their online purchases may be compromised or curtailed as well.

Typically the user of the ecommerce site does not have purchasing leverage beyond their single user status. The shopper at the ecommerce site may experience that their leverage to developing good deal on a particular desired item that has high value and low cost is limited or nonexistent due to only having a single sale engagement potential with the seller. Additionally, the user has no way of developing competition between sellers which would present better deal offerings by price and item description to all shoppers navigating the ecommerce site.

### BRIEF DESCRIPTION OF DRAWINGS

Some embodiments are illustrated by way of example and not limitation in the figures of the accompanying drawings in which:

FIG. 1 is a diagrammatic representation of a network environment including an online marketplace hosting buyer-solicited offerings, according to example embodiments;

FIG. 2 is a block diagram illustrating a system to provide buyer-solicited offerings, as may be used in example embodiments;

FIG. 3 includes flowcharts illustrating methods pertaining to creation of a buyers' group and a desired-item listing at an online marketplace, according to example embodiments;

FIG. 4 is a flow chart illustrating a method of maintaining a purchase-commitment count according to a received purchase commitment, as may be used in example embodiments;

FIG. 5 is a flow chart illustrating a method to secure funding and shipping commitments relating to a purchase commitment, according to example embodiments;

FIG. 6 is a flow chart illustrating a method of seller bidding, as may be used in example embodiments;

FIG. 7 is a flow chart illustrating a method to maintain a purchase-commitment count relating to seller bidding, according to example embodiments;

FIG. 8 is a flow chart illustrating a method to determine a purchase-commitment threshold is met, as may be used in example embodiments;

FIG. 9 is a flow chart illustrating a method to activate funding and shipping relating to meeting a purchase-commitment threshold, according to example embodiments;

FIG. 10 is a block diagram illustrating a desired-item search interface at an online marketplace, as may be used in example embodiments;

FIG. 11 is a block diagram illustrating an item listing interface at an online marketplace, according to example embodiments; and

FIG. 12 is a block diagram of a machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

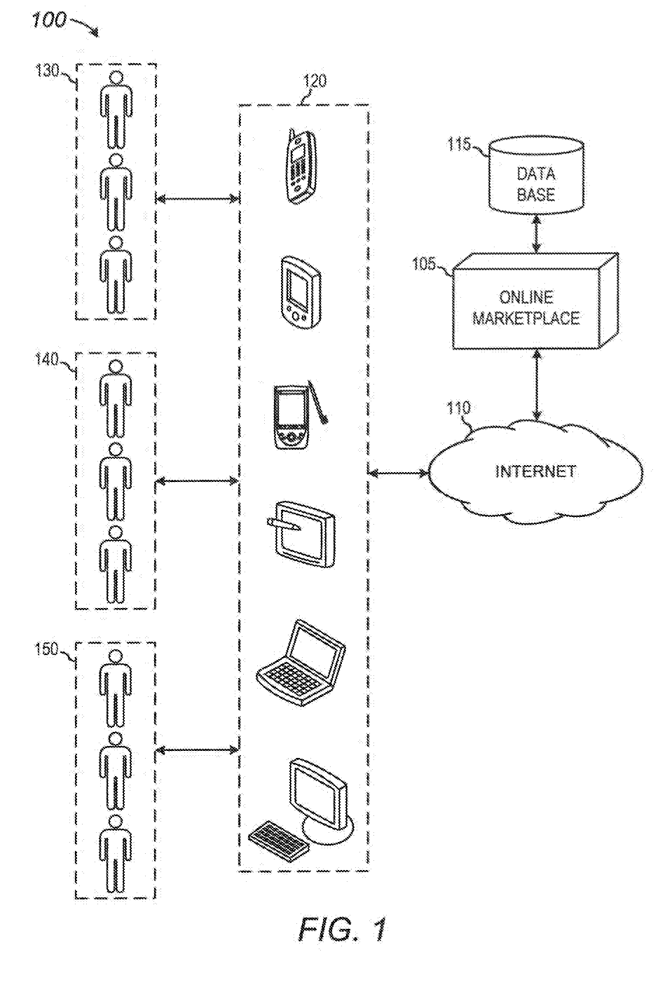

FIG. 1 is a diagrammatic representation of a network environment 100 including an online marketplace 105 to host buyer-solicited offerings, according to example embodiments. The online marketplace 105 is communicatively coupled to a computer network, which may be for example the Internet 110. The online marketplace 105 may also be communicatively coupled to a database 115, which may be used to store descriptions and listings relating to the buyer-solicited offerings. The online marketplace 105 and the database 115 may correspond to at least a portion of a server, for example. A device 120 may be communicatively coupled to the Internet 110 and used by a buyer 130, a seller 140, or a further seller 150 to communicate through the Internet 110 to the online marketplace 105. One skilled in the art will readily appreciated that the buyer 130 may represent one or more buyers, and similarly the seller 140 and the further seller 150 may represent or refer to one or more sellers and further sellers respectively. The device 120 can correspond to many different types of devices that may be, for example, a cell phone, a smart phone, a personal data assistant (PDA), a tablet, a notebook computer, or a desktop computer to name but a few of possible personal electronic devices usable by the buyer 130, the seller 140, or the further seller 150 to establish communications with the online marketplace 105.

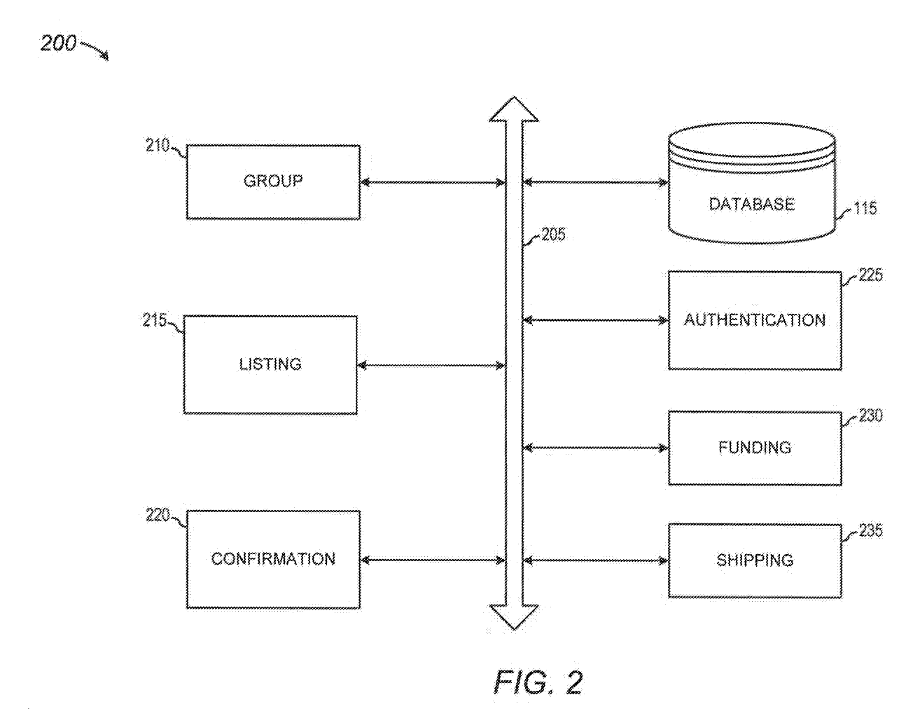

FIG. 2 is a block diagram illustrating a buyer-solicited offerings system 200, as may be used in example embodiments. The buyer-solicited offerings system 200 may reside within the online marketplace 105 (FIG. 1) and may be implemented as a portion of a server, for example. The buyer-solicited offerings system 200 may include a processor (not shown) communicatively coupled through the computer network and a local bus 205 to the database 115.

The buyer-solicited offerings system 200 can include a group module 210 to determine the existence of a buyers' group within the buyer-solicited offerings system 200 and create a buyers' group when the buyers' group is determined to not exist. The buyers' group (below) is a collection of potential or confirmed buyers who have expressed an interest in a desired item or desired items that may or may not have item listings of offerings to sell an item or items corresponding to the desired item(s).

When a description of a desired item or description of an item for sale is received by the buyer-solicited offerings system 200, a listing module 215 may produce a corresponding desired-item listing or an item listing for the desired item or the item for sale, respectively. A description of a desired item transmitted from the device 120 of the buyer 130 and a description of an item for sale transmitted from the device 120 of the seller 140 can be provided to the listing module 215 can cause a corresponding desired-item listing and an item listing respectively to be created by the listing module 215.

A confirmation module 220 may be used to manage confirmation of a purchase commitment received from the device 120 of the buyer 130 and maintain marketing metrics relating to confirmed purchase commitments. marketing metrics for the buyers' group may include, for example, a total number of items sought for purchase, a total number of items offered, a total number of offers (deals) by sellers, a total number of items subject to a purchase commitment, a total number of items sold, a total number of buyers, and a total number of sellers. The purchase commitment may be received by the buyer-solicited offerings system 200 in response to the buyer 130 being motivated to buy an item for sale at the buyers' group. The item for sale may be presented in an item listing in the buyers' group within the online marketplace 105. The purchase commitment by the buyer 130 may be received from the device 120 and cause a corresponding increase in a purchase-commitment count and a need for a comparison of the incremented purchase-commitment count to a purchase-commitment threshold. The purchase commitment by the buyer 130 may be a commitment to purchase a single item or multiple items as a single submitted purchase commitment. The corresponding purchase-commitment count may typically be a count of the total number of items subject to the purchase commitments submitted by the buyers. The corresponding purchase-commitment count may be, according to further example embodiments, a count of purchase commitments made by buyers, where each purchase commitment may be for a single item, multiple items, or any combination of single or multiple items made by buyers. The purchase-commitment threshold can be the number of confirmed item sales necessary to consummate the sale of the items corresponding to the item listing.

The confirmation module 220 can manage the incrementing of the purchase-commitment count upon receipt of a purchase commitment and manage a corresponding comparison to the purchase-commitment threshold to determine if the required number of purchase commitments is met to trigger the sale of the items. The confirmation purchase-commitment count to the corresponding item listing in the buyers' group. In this way, the confirmation module 220 may manage marketing metrics relating to purchase commitments that provide buyers and sellers, who are navigating the buyers' group, a way to judge the proximity of a sale of the items corresponding to the item listing.

An authentication module 225 may be included in the buyer-solicited offers system 200 to authenticate a financing commitment and shipping details included in the purchase commitment presented by the buyer 130. Authentication of financing and shipping data may be provided by the authentication module 225 working together with modules relating to funding and shipping (below), which may be provided by third parties.

A finding module 230 may be communicatively coupled through the local bus 205 to the authentication module 225 to receive indications to secure funding and activate funding relative to a purchase commitment from the buyer 130. The funding module 230 may be in communication with a financier (not shown), for example, to secure financing through a hold on funds that the buyer 130 may have in place with the financier. The amount of funds subject to the hold may correspond to a price for an item described in the item listing as presented at the buyers' group. The funding module 230 may also consummate activation of the funding to the seller 140 at the time a sale is confirmed. The funding and the item listing may also include further cost items that may cost the buyer 130, such as taxes, shipping fees, and handling fees. These further cost items may be included in the amount of funds subject to hold at the financier. A shipping module 235 may be communicatively coupled through the local bus 205 to the authentication module 225 to receive indications to transmit shipping data to a shipper (not shown) and to activate shipping of an item from the seller 140 to the buyer 130 at the time the sale is confirmed.

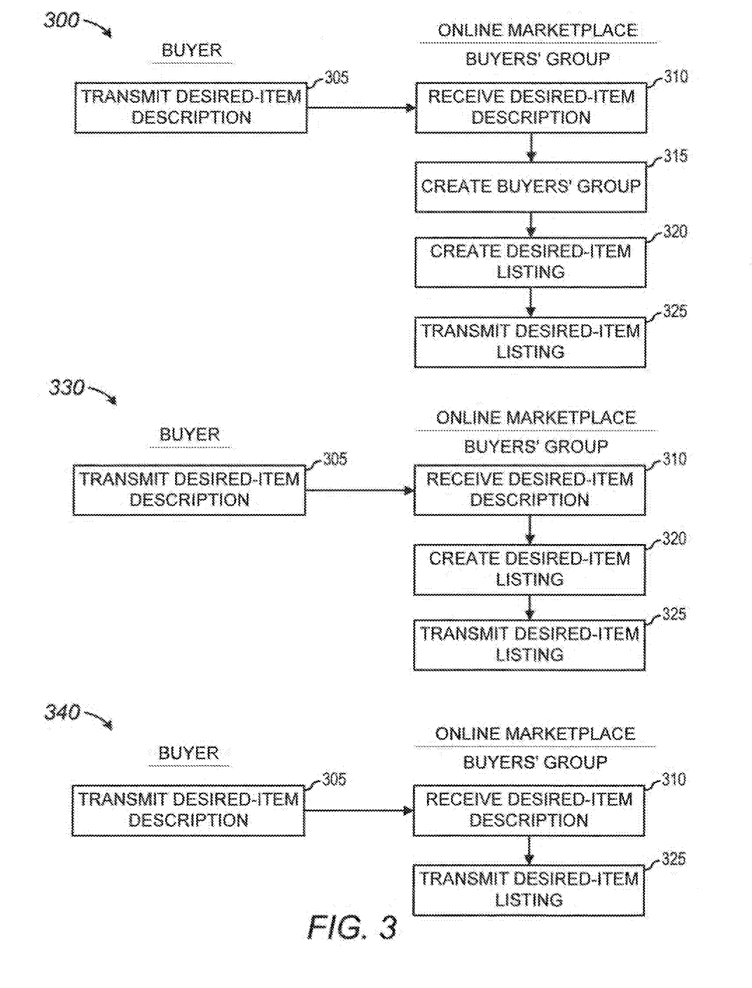

FIG. 3 includes flowcharts illustrating methods to create a buyers' group and a desired-item listing 300 at the online marketplace 105, according to example embodiments. The methods pertaining to creation of the buyers' group and desired-item listing 300 may be performed by any of the modules, logic, or components described herein. A flow chart depicting creation of a buyers' group and a desired-item listing 300 commences with a buyer transmitting a desired-item description with the device 120 in their possession and cause the description to be transmitted from their location, through the Internet 110, and to the buyers' group at the online marketplace 105.

At the online marketplace 105, the buyers' group may receive the desired-item description 310 from the device 120 of the buyer 130. The desired-item description may describe an item commonly available in the instant marketplace or may be a rare or collectible item which may not commonly occur or be described in a contemporary marketplace. However the desired-item description is the description of an item that buyers and sellers of at least certain marketplaces would recognize. For example, the desired-item description may describe a collectible car or antique automobile, that may not commonly occur within an item listing at a general marketplace. The desired-item description may include a description of an item that a buyer or seller generally involved with automobiles or antiques would recognize.

The desired-item description may include at least one characteristic of the desired-item that the buyer 130 desired to buy. The at least one characteristic of the desired-item description includes words and descriptive phrases that the buyer 130 may believe best described the item they desire to buy and seek to have listed at the buyers' group. These descriptive phrases are also meant to entice further buyers and sellers to the buyers' group so that offerings to sell items corresponding to the desired-item may be solicited by numerous sellers, and which offerings may be enticed by a large number of further buyers. The at least one characteristic of the desired-item may be a type of device, a model name, a brand, a version, a color, a price, and a window of time, for example. Corresponding to example embodiments, one or more desired-item characteristics may be sufficient to describe a particular model, capacity, version, and time for consummating the sale and delivery of the desired item to the buyer 130.

In response to the receiving the desired-item description from the buyer 130, the online marketplace 105 may determine that the buyers' group corresponding to the desired-item description and the at least one characteristic does not exist. The buyer 130 may initiate a search for the desired-item by submitting the description within a terminal session with the online marketplace 105 as conducted through the device 120, for example. If the buyer 130 submits a desired-item description that has not been previously received by the online marketplace 105, the corresponding buyers' group is created. Creating the buyers' group 315 involves including a group characteristic corresponding to the at least one characteristic contained in the desired-item description. Creating the buyers' group 315 may be included within a process 300 to create a buyers' group and create a desired-item listing and be triggered by the buyer 130 transmitting the desired-item description 305.

Creating the desired-item listing 320 may be included within a process to create a desired-item listing 330. In further example embodiments, the buyer-initiated search may determine that the desired-item listing does not exist at the buyers' group site even though the corresponding buyers' group does exist. When this situation occurs, the buyers' group begins creating the desired-item listing 320 corresponding to the desired-item description and includes the at least one characteristic in the desired-item listing. The process to create a desired-item listing 330 may be triggered by the buyer 130 transmitting the desired-item description 305 when the buyers' group already exists.

After creating the buyers' group 315 and creating the desired-item listing 320, as may be necessary in particular example embodiments, the buyers' group continues with transmitting the desired-item listing 325, that corresponds with the desired-item description, to members of the buyers' group and interested sellers who may snoop the buyers' group. The marketing metrics corresponding to the buyers' group may also be updated to reflect an increase in the total number of items sough for purchase and the total number of buyers, for example.

A process to transmit a desired-item listing 325 may be initiated by transmitting a desired-description 305 when the buyers' group and the desired-item listing already exists. After receiving the desired-item description 310, which may have been transmitted by the buyer 130 (as described above), the buyers' group may transmit the desired-item listing 325 to buyers' group members.

By use of the term “transmitting,” one skilled in the art will recognize that an entity such as the buyers' group, as hosted by the online marketplace 105, and through means such as the network environment 100, may make available the desired-item listing through the Internet 110 to the device 120 of the buyer 130 and the device 120 of the seller 140. Alternatively, the buyer 130 and the seller 140 may encounter the desired-item listing at the buyers' group during their navigation through the online marketplace 105 with the device 120.

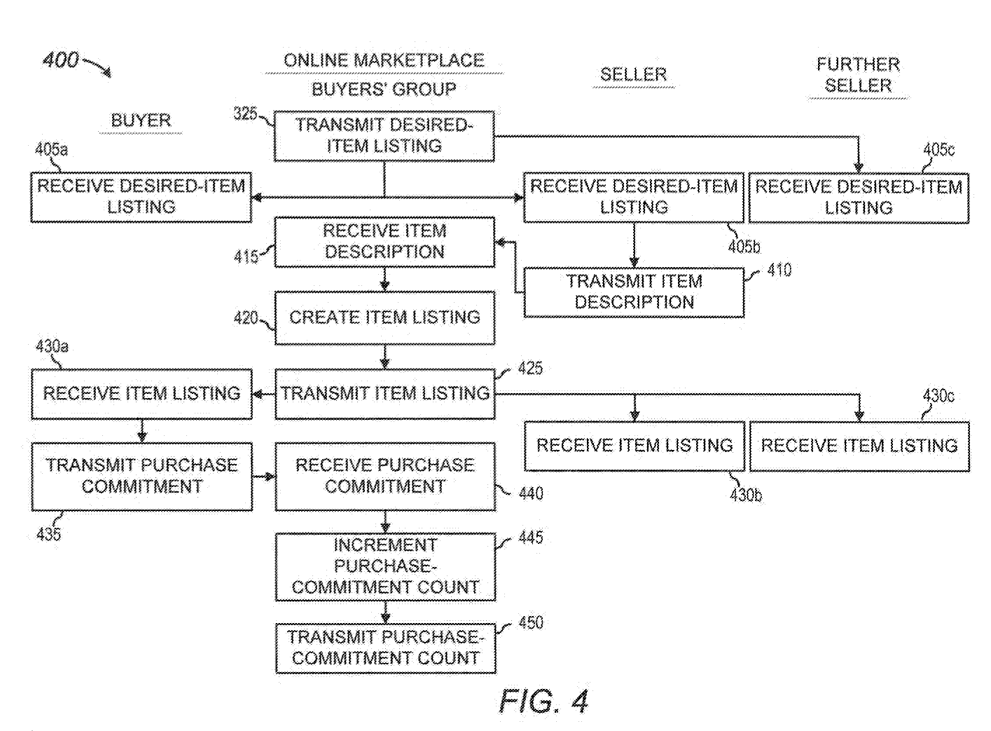

FIG. 4 is a flow chart illustrating a method of maintaining a purchase-commitment count 400 according to a received purchase commitment, as may be used in example embodiments. The method of maintaining the purchase-commitment count 400 may be performed by any of the modules, logic, or components described herein.

The process of maintaining the purchase-commitment count 400 commences with transmitting the desired-item listing 325 to the buyer 130, the seller 140, and a further seller 150 (FIG. 3). As described above, the desired-item listing corresponds to the desired-item description. The desired-item listing may be “transmitted” to the buyer 130, the seller 140, and the further seller 150 in the sense that a posting of the desired-item listing is available at the buyers' group site. The buyer 130, the seller 140, and the further seller 150 may receive the desired-item listing 405a,b,c as they navigate the buyers' group at the online marketplace 105.

The seller 140 may navigate to the buyers' group during a terminal session with the device 120 at the online marketplace 105. In reviewing the desired-item listing, the seller 140 may determine that items the seller 140 may wish to sell match closely with the description contained within the desired-item listing. For example, the seller may have smart phones that are the same make and model described in the desired-item listing. Accordingly, the seller 140 may wish to provide an offer to sell these items in the buyers' group and present them as an offering for sale within an item listing at the buyers' group.

In order to initiate the offer to sell the items, the seller 140 may transmit an item description 410 to the buyers' group. The item description (not shown) may include a description of an item or items that the seller 140 is offering to sell at the buyers' group. The item description may not match exactly with the desired item description submitted by the buyer 130 in the desired-item listing, but the seller 140 may decide that an item or items that the seller has to sell may match the description of the desired-item listing closely enough that it is worthwhile to transmit the item description 410.

According to some example embodiments, the seller 140 may have additional items to include in their offering that may be included in the item description and enhance or give alternative incentives to the buyer 130 to purchase the main item in the item description. For example, the item description may include accessories, carrying cases, tools, additional supplies, and warranties. The item description may also include sale incentives such as coupons, gift cards, vouchers, and credit. These further sale incentives and additional items may be provided by the seller 140 to enhance the offering and incentivize the buyer 130 to purchase the item. These sale incentives and further item descriptions may also be positioned by the seller 140 within the item description to entice the buyer 132 a further purchase at a later time and perhaps at a further listing.

The further sale incentives and the additional items may be provided by the seller 140 to differentiate their offering from an offering provided by the further seller 150. The seller 140 may position the further sale incentives and the additional items to make their item description more enticing for purchase by the buyer 130 than a further offering by the further seller 150. These offerings may induce further purchases of items that logically accompany the item in the item description. Example embodiments may include a voucher or coupon for a discount or special offering price during a particular period of time for travel when the item description includes admission tickets and accommodations at a theme park. Wheel coverings and cleaning supplies may accompany an item description for a set of new tires for a car, according to further example embodiments.

The item description provided by the seller 140 may also include particular circumstances or conditions pertaining to the offering. For example, the seller 140 will include the total number of items to be committed for purchase by the buyers in order for the sale to be completed (e.g., purchase-commitment threshold). The seller 140 may include a period of time that the offering is valid either by supplying an offering end-date, a window of time, or a number of days remaining that the offering is in effect.

At the online marketplace 105, the buyers' group may receive, from the seller 140, the item description 415 that corresponds to the desired-item listing. In response to receiving the item description 415, the buyers' group may create an item listing 420 corresponding to the item description and include the at least one characteristic. Once created, the item listing may be transmitted 425 from the buyers' group to the buyer 130, the seller 140, and the further seller 150. The item listing is received 430a,b,c by the buyer 130, the seller 140, and the further seller 150. The item listing corresponds to the item description and includes the at least one characteristic from the item description and the desired-item description. Additionally, the marketing metrics for the buyers' group may be updated to maintain the total number of offers, the total number of items offered, and the total number of sellers, for example.

The buyer 130, after receiving the item listing 430a and reviewing the offer to sell (also known as a “deal”) may decide they want to try and purchase the item described in the item listing. As part of the buyers' group, the buyer 130 realizes that they must submit their indication of a desire to buy the item by transmitting a purchase commitment 435 to the buyers' group and online marketplace 105. The purchase commitment may be for a single item or multiple items. The indication by the buyer 130 of a desire to buy the item is expressed by the buyer 130 transmitting the purchase commitment 435 to the buyers' group. The purchase commitment may be counted, after a confirmation process, as one of a purchase-commitment count towards matching a purchase-commitment threshold designated in the item listing by the seller 140 that must be met in order for the sale of the items to be consummated. The purchase-commitment count may be a count of the total number of items sold and the purchase-commitment threshold may be the number of items that must be sold in order for the sale to be consummated.

According to further example embodiments, the purchase-commitment count may be a count of purchase commitments made by buyers, where each purchase commitment may be for a single item or multiple items. According to other example embodiments, the purchase-commitment count may be a count of purchase commitments made by buyers where any given purchase commitment may be for either a single item or for multiple items and the purchase-commitment count may be made up of any combination of single item or multiple item purchase commitments. According to example embodiments, such a purchase-commitment count may be maintained when a total number of shipments corresponding to the purchase-commitment count triggers a shipping cost benefit to the seller 140 that is incentive to consummate the sale and where the total number of items sold is not critical.

The buyers' group may receive the purchase commitment 440 corresponding to the item listing from the device of the buyer 130. In response to receive the purchase commitment 440, the buyers' group increments a purchase-commitment count 445 corresponding to the item listing and maintained at the online marketplace 105. In response to incrementing the purchase-commitment count 445, the buyers' group transmits the purchase-commitment count 450 as an update to the item listing available to buyers' group members. Additionally, marketing metrics for the buyers' group may be maintained by incrementing a number of items subject to a purchase commitment and the total number of buyers, for example. In this way, the buyer 130, the seller 140, and the further seller 150 may be kept up to date of the proximity to a sale of the items described in the item listing by comparing the purchase-commitment count with the purchase-commitment threshold published in the item listing.

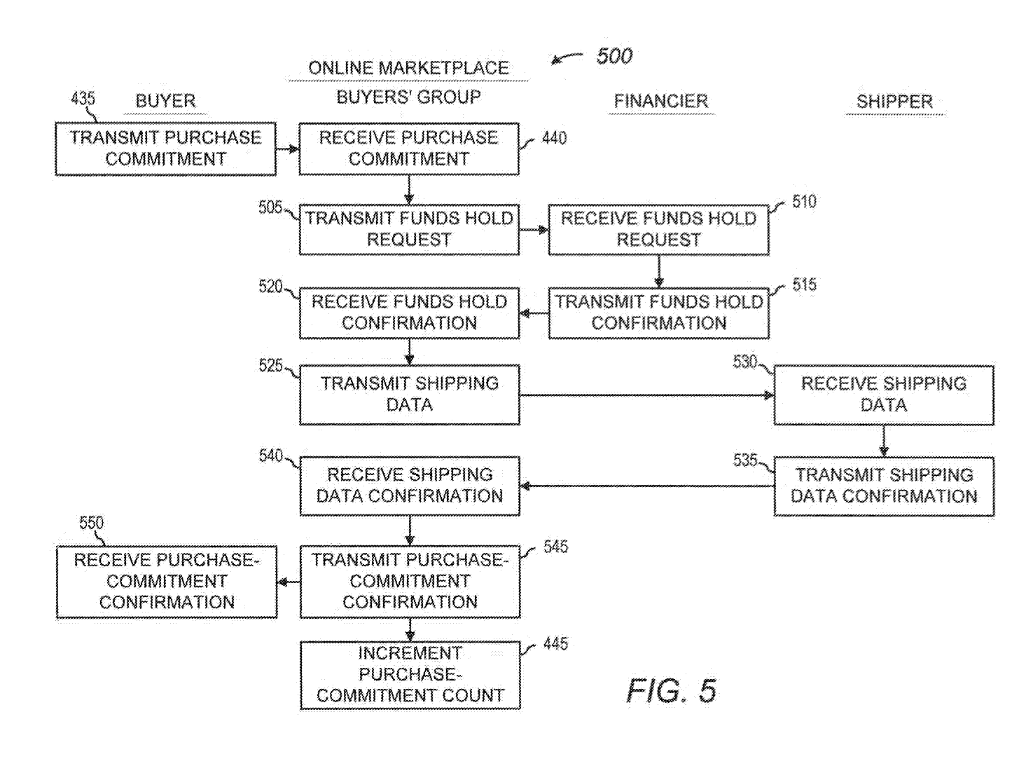

FIG. 5 is a flow chart illustrating a method to secure funding and shipping commitments 500 relating to a purchase commitment, according to example embodiments. The method to secure funding and shipping commitments 500 may be performed by any of the modules, logic, or components described herein.

After receiving the purchase commitment 440 from the buyer 130, a funds hold request 505 may be transmitted to a financier or a financial institution as part of a buyer authentication process. The funds hold amount may correspond to a price given in the item listing. The financier may receive the funds hold request 510. After reviewing and confirming that the buyer 130 has sufficient funds on hand with the financier, a funds hold confirmation may be transmitted 515 from the financier to the buyers' group. The communications and transactions between the buyers' group in the financier may be conducted with the funding module 230 (FIG. 2).

In further response to receiving the purchase commitment 440, the buyers' group may transmit shipping data 525 received as a portion of the purchase commitment, to a shipper or shipping agent according to example embodiments. The buyers' group may use the shipping module 235 to conduct communications and any inquired transactions with the shipper. After the shipper receives the shipping data 530, a shipping data confirmation is transmitted 535 to the buyers' group at the online marketplace 105. The buyers' group may receive from the shipper, the shipping data confirmation 540 through the shipping module 235.

Subsequent to receiving the funds hold confirmation 520 and after receiving a shipping data confirmation 540, the buyers' group transmits a purchase commitment confirmation 545 corresponding to the item listing to the buyer 130. The buyer 130 receives the purchase commitment confirmation 550 and knows that the funds hold request has been confirmed with the financier and the shipping data received by the shipper. Additionally, after receiving the funds hold confirmation 520 and after receiving the shipping data confirmation 540, the buyers' group may increment the purchase-commitment count 445. In this way, the purchase commitment transmitted by the buyer 130 to the buyers' group places the buyer 130 in a position known to place them in line for receiving an item described in the item listing once a sufficient number of sold items to match the purchase-commitment threshold is accumulated.

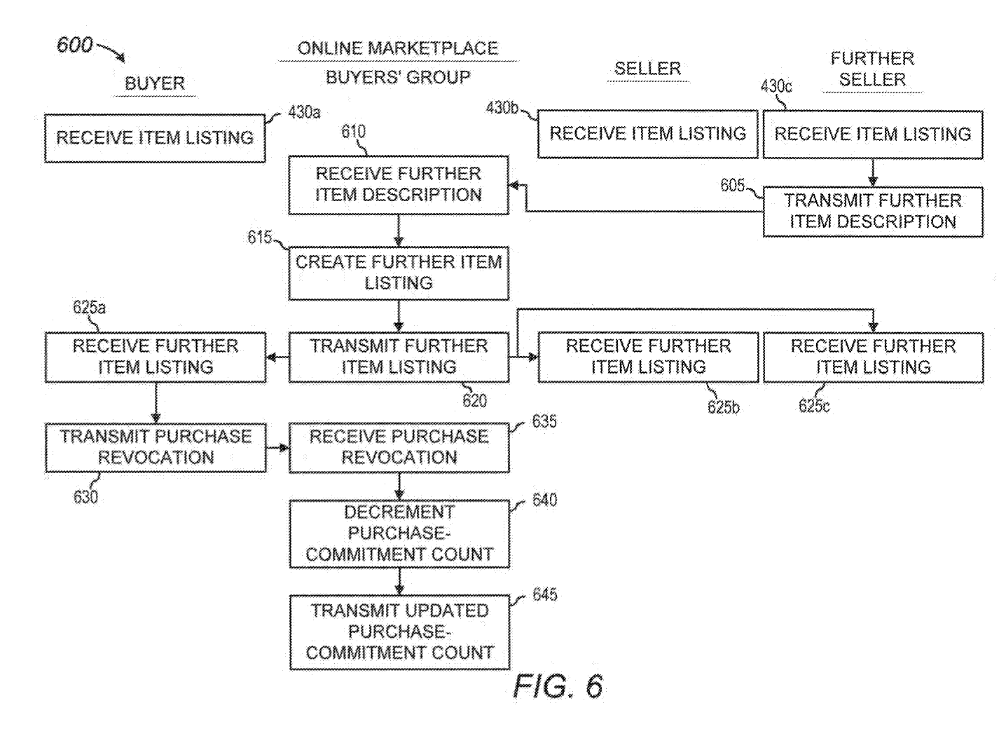

FIG. 6 is a flow chart illustrating a method of seller bidding 600, as may be used in example embodiments. The method of seller bidding 600 may be performed by any of the modules, logic, or components described herein.

The further seller 150, after receiving the item listing 430c may realize that they also have items they wish to sell that match the item description in item listing. In the event the further seller 150 wishes to commence a process to try and sell the items, the further seller 150 may transmit a further item description 650 to the buyers' group at the online marketplace 105. From the device 120 of the further seller 150, the buyers' group may receive a further item description 610 corresponding to the desired-item listing and including the at least one characteristic included in the desired-item description. By transmitting the further item description 605, the further seller 150 initiates a process known as seller bidding. By being able to receive item listings 430c from other sellers, the further seller 150 may be able to position a further item listing to draw the buyer 130 away from making a purchase commitment with some other seller 140 and their corresponding items listing. By transmitting a further item description 605 that includes characteristics about the item for sale or conditions about the sale, such as price, accessories, warranty or sale timeframe, for example, the further seller 150 made trigger creation of a further item listing that in effect it's against a previous listing made by the seller 140.

According to certain example embodiments, upon receiving the further item description 610, the further item description may be provided to the listing module 215. The listing module 215 can create the further item listing 615 based on characteristics and designators included in the description. The buyers' group can transmit the further item listing 620 to the buyers' group member. Corresponding to the transmitting of the further item listing 620, marketing metrics for the buyers' group may be maintained by incrementing the total number of items offered, the total number of offers, and the total number of sellers, for example. The buyer 130, the seller 140, and the further seller 150 may receive the further listing 625a,b,c as they navigate the buyers' group at the online marketplace 105. For instance, the buyer 130 may receive the further item listing 625a and determine that the deal provided in the further item listing is much better for the buyer 130 than the deal offered in the item listing the buyer 130 may have committed to previously. The buyer 130 may decide to transmit a purchase revocation 630 to the buyers' group at the online marketplace 105 to revoke the previous purchase commitment and thus be free to choose a further purchase commitment for the next offering by the further seller 150. Accordingly, the marketing metrics corresponding to the buyers' group may be updated by decrementing the total number of items subject to a purchase commitment, for example.

The buyers' group receives the purchase revocation 635 from the buyer 130 which corresponds to the previous purchase commitment. The buyers' group May decrement the purchase-commitment count 640 corresponding to the first item listing to produce an updated purchase-commitment count. The buyers' group continues this revocation process by transmitting to the buyers' group members, an update too the item listing for the first item which include the updated (decremented) purchase-commitment count 645. In this way the buyer 130 is able to take advantage of a further item listing that presents a better deal for the buyer 130 and the maintaining of sold item metrics is upheld. The confirmation module 220 may be utilized to maintain these metrics relating to sold item dynamics.

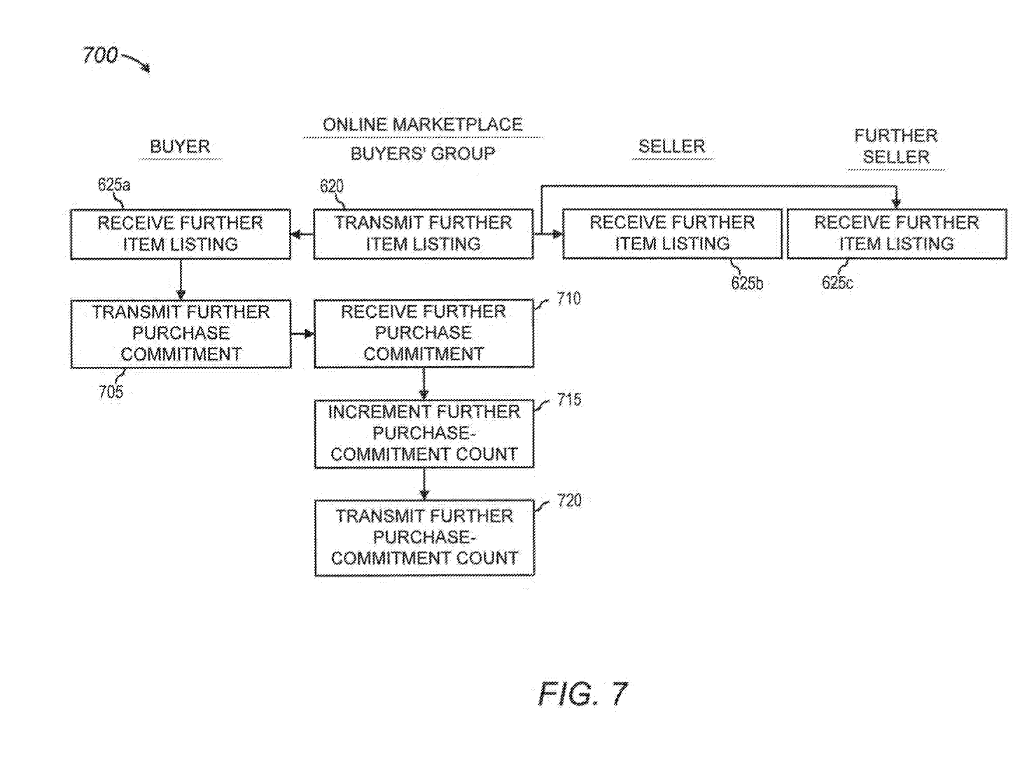

FIG. 7 is a flow chart illustrating a method to maintain a purchase-commitment count 700 relating to seller bidding, according to example embodiments. The method to maintain the purchase-commitment count 700 may be performed by any of the modules, logic, or components described herein.

As described above, transmitting the further item listing 620 to the buyers' group members (FIG. 6), where the further item listing may contain a better deal than a previous item listing, may cause the buyer 130 to revoke the previous purchase commitment corresponding to the first item. It may follow soon after, according to some example embodiments, that the buyer 130 transmits a further purchase commitment 705 after receiving the further item listing 625a. In response to receiving the further purchase commitment 710, the buyers' group may increment a further purchase-commitment 715. The confirmation module 220 may attend to the incrementing of the further purchase-commitment count in a fashion similar to that described above in relation to incrementing the purchase-commitment count corresponding to the first item listing. The buyers' group may transmit to the buyers' group members, an update to the further item listing, including the further purchase-commitment count 720. The marketing metrics corresponding to the buyers' group may be maintained by incrementing the total number of items subject to a purchase commitment, for example.

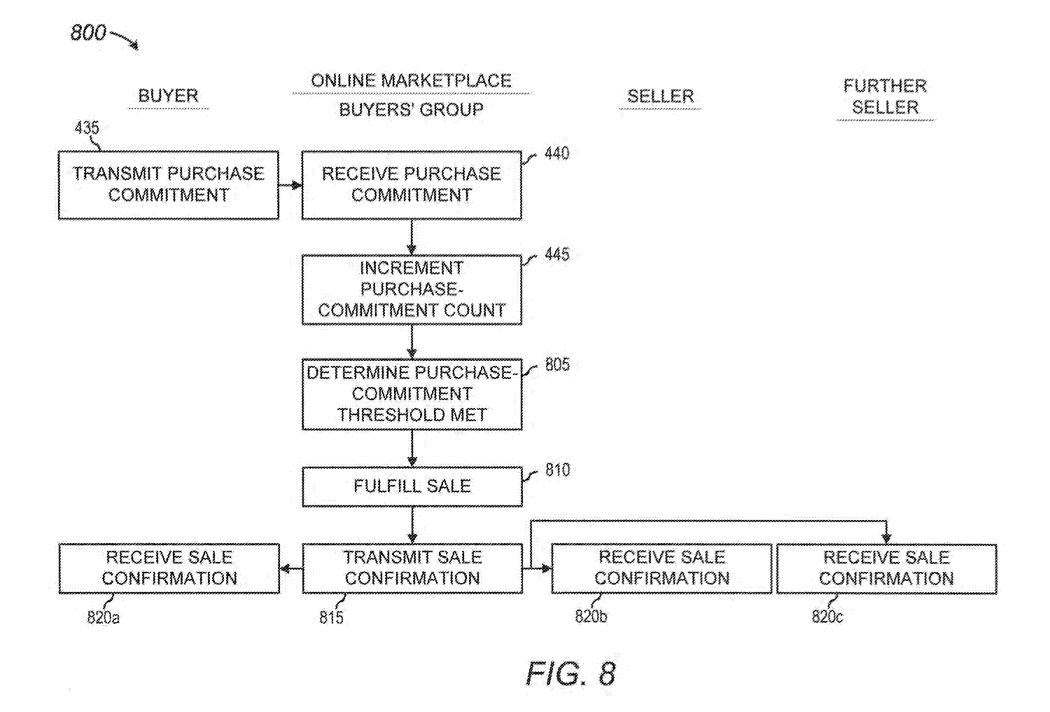

FIG. 8 is a flow chart illustrating a method to determine a purchase-commitment threshold is met 800, as may be used in example embodiments. The method to determine a purchase-commitment threshold is met 800 may be performed by any of the modules, logic, or components described herein.

In response to receiving the purchase commitment 440, the buyers' group at the online marketplace 105 increments the purchase-commitment count 445 corresponding to the first item listing. In response to the incrementing of the purchase-commitment count 445, the confirmation module 220 may determine that the purchase-commitment threshold is met 805. Steps to fulfill the sale 810 are taken, such as transmitting a sale confirmation 815 from the buyers' group to the buyers' group members. Each of the buyer 130, the seller 140, and the further seller 150 may receive a sale confirmation 820a,b,c as they navigate the buyers' group at the online marketplace 105. Accordingly, the marketing metrics corresponding to the buyers' group may be maintained by incrementing the total number of items sold in correspondence to the number of items subject to the sale confirmation.

Receiving the sale confirmation 820a,b,c signifies that the required number of items determined by a threshold place in the item listing by the seller 140 or further seller 150 has been met and that the steps to fulfill the sale 810 have been taken. The offering for the sale item subject of the item listing is closed and the item listing itself will be withdrawn from the buyers' group at the online marketplace 105. According to some example embodiments, a running tally of the total number of sale items sold may be maintained in the marketing metrics. The number of sale items included in the instant sale are added to the total number of sale items in the online marketing metrics and update accordingly. After receiving the sale confirmation 820a, the buyer 130 that has successfully completed the purchase of an item that is the subject of the item listing, will no longer be a member of the buyers' group. This leaves the buyer 130 able to visit the buyers' group at any time and commence a further purchase; but in the meantime, no further transmissions are received by the buyer 130 that might otherwise be an inconvenience, given they have purchased the item.

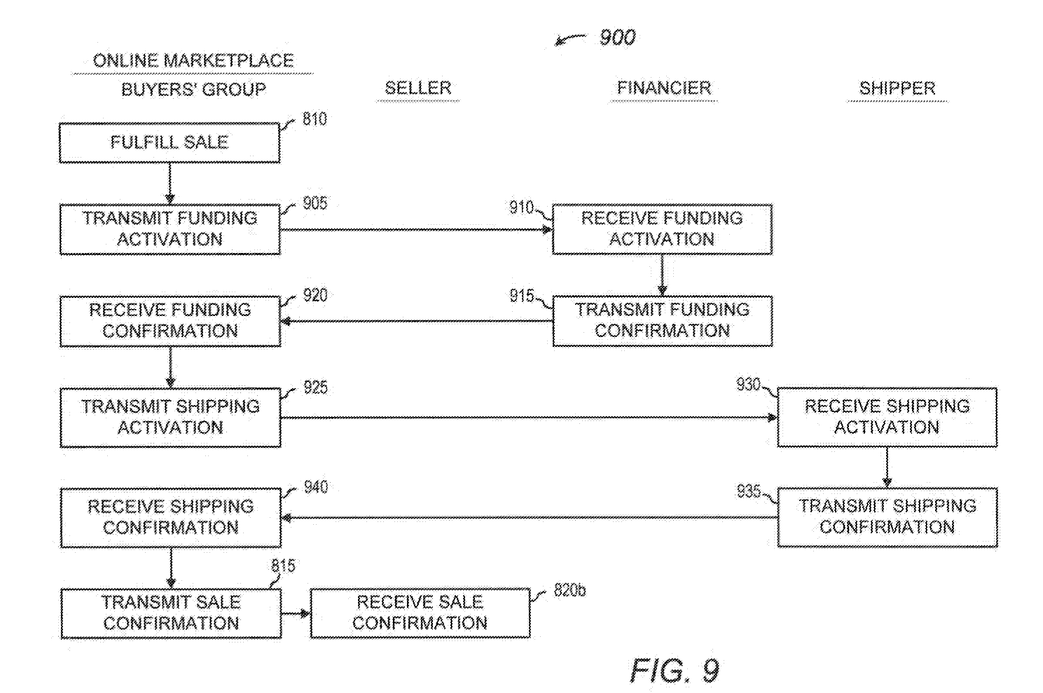

FIG. 9 is a flow chart illustrating a method to activate funding and shipping 900 relating to meeting a purchase-commitment threshold, according to example embodiments. The method to activate funding and shipping 900 may be performed by any of the modules, logic, or components described herein.

In response to receiving the purchase commitment 440 from the buyer 130 that determined the purchase-commitment threshold is met 805, the funding module 230 and the shipping module 235 are called on to fulfill the sale 810. The funding module 230 may commence this process by transmitting a funding activation 905 to the device 120 belonging to the financier. The funds hold, confirmed by the financier, is activated and the funds released to the seller 140 according to the terms established in the buyer authentication process (above). Release of the funds being held according to the purchase commitment takes place as the financier transmits a funding confirmation 915 to the buyers' group. Utilizing the funding module 230, the buyers' group receive the funding confirmation 920 from the device 120 of the financier.

The buyers' group continues to fulfill the sale 810 by transmitting a shipping activation 925 to the shipper. The shipping data retained with the shipper is utilized to schedule delivery of the item sold to the buyer 130. Address information, a schedule of availability for signing the delivery package by the buyer 130, and service level and rate selections are released to the seller 140 and appropriate branches of the shipper's organization. In this way the seller 140 may address delivery packages and establish a pickup schedule at the location of the seller 140 and a delivery schedule at the location of the buyer 130. Once the addressing, service-level, and scheduling is released to the seller 140 and the shipper's organization, the shipper continues by transmitting a shipping confirmation 935. The buyers' group receives the shipping confirmation 940 from the device 120 of the shipper and transmission of a sale confirmation 815 to the buyers' group members is initiated.

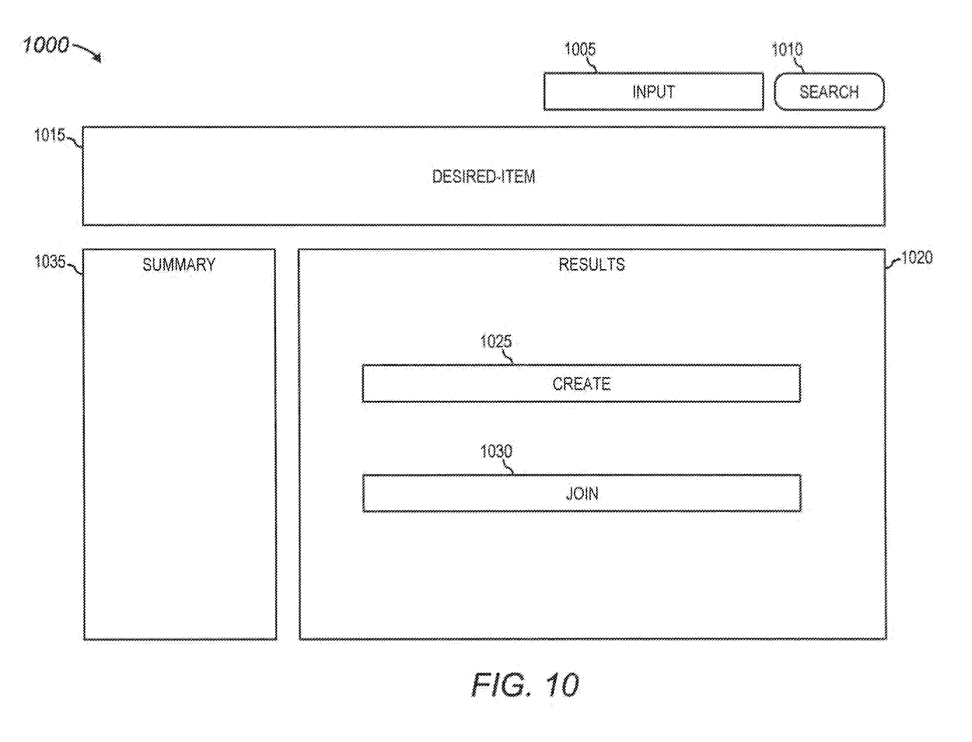

FIG. 10 is a block diagram illustrating a desired-item search interface 1000 utilized at the online marketplace 105, as may be used in example embodiments. The desired-item search interface 1000 includes an input field 1005 where search terms such as product or model names may be entered and a search button 1010 may be activated to initiate a search for a users' group corresponding to the search term. A desired-item field 1015 may display the accumulation and relationship of search terms entered at the input field 1005.

By successively applying new search terms to the input field, a desired item description may be built up in the desired item field 1015. After each successive application of a further search term arrangement in the input field 1005, the results of locating a buyers' group corresponding to the characteristics contained in the desired-item description are displaced in the results field 1020. When no buyers' group corresponding to the desired-item description is located, a message to that effect may be displayed in the results field 1020 and a create button 1025 may be displayed above the results field 1020. On activation, the create button 1025 may cause a users' group corresponding to the desired item description to be created in the online marketplace 105.

When a buyers'group corresponding to the desired-item description is located, a message to that effect may be displayed at the results field 1020 and a join button 1030 may be displayed above the results field 1020. On activation, the join button 1030 may cause the buyer 130 to be presented with further data input fields to specify profile indicators corresponding to the buyer 130.

A summary field 1035 within the desired-item search interface 1000 may display summary information relating to certain quantities and characteristics relating to the buyers' group, when one exists for the desired-item description entered by the buyer 130. For instance, according to some example embodiments, the summary field 1035 may include numbers corresponding to individual buyers, items sought, sellers participating in the present group, number of offerings (deals), and the total number of items for sale.

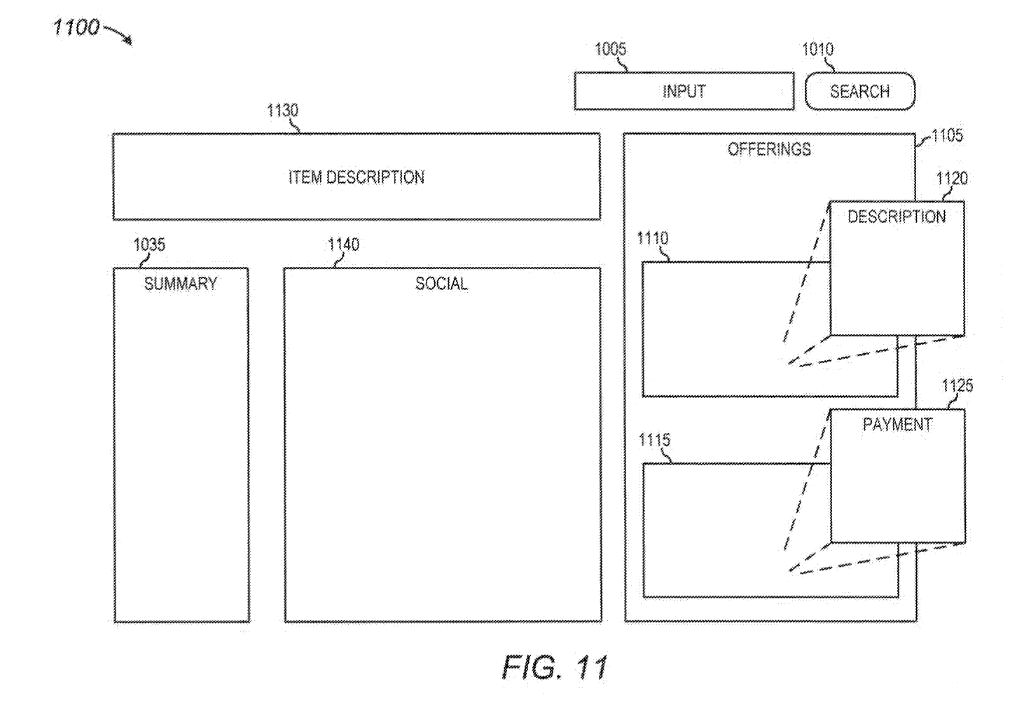

FIG. 11 is a block diagram illustrating an item listing interface 1100 at an online marketplace, according to example embodiments. The input field 1005 and the search button 1010 corresponding to the desired-item search interface 1000 are also present in the item listing user interface 1100. Search terms, commands, and general designating entries may be entered in the input field 1005. Once a desired-item description is entered in the desired item field 1015 (FIG. 10) and a corresponding desired-item listing in a buyers' group is located, the item description and/or the desired-item listing may be displayed in an item description field 1130. Additionally, the item listings 1110, 1115 found in the corresponding search may be displayed in the offerings field 1105. The item listings 1110, 1115 may present pictures of items for sale, prices, and product descriptions including model, manufacture, capacity, size, offering time window, and price, for example. Click-selectable links to further descriptions, a manufacturer's site, or a further seller's site may also be included in the item listings 1110, 1115 to provide further descriptive input to the shopper to describe the item offering, according to example embodiments.

By hovering a computer-generated cursor above the item listings 1110, 1115, the user interface 1100 may display in a pop up region, a detailed item description 1220. By moving the computer-generated cursor around the item listings 1110, 1115 further description details may appear corresponding to the position within the item listings 1110, 1115. By panning around the item listings 1110, 1150 in this manner, a user of the item listing interface 1100 may view the complete set of details describing the item listings 11110, 1115.

By hovering the computer-generated cursor above certain other portions of the item listings 1110, 1115, the user interface 1100 may display payment details 1125 relating to the offering of the seller 140. The payment details may specify the price, financing terms, associated fees, and approved financial institutions with which the final purchase of the item, subject of the item listings 1110, 1150 may be conducted.

A social field 1140 may be presented within the item listing interface 1100 to provide a social wall for buyers-group members to enter relate with one another in a social network related to the desired-item listing and subject of the instant users' group. The social field 1140 may be provided by the item listing interface 1100 to support social networking activity amongst buyers, potential buyers, sellers, and interested parties in general. The social field 1140 may interact with, support, or extend an existing social network available to certain of the buyers through the Internet 110 in general or through a separate social networking site. A buyers' group-specific social network may be supported by the social field 1140. The buyers' group-specific social network and other social networks at large may call me go and interact seamlessly through the social field 1140.

Buyers and potential buyers may express their interest or enthusiasm in purchasing the desired item that is subject of the desired-item description and the desired-item listing. Potential buyers, buyers, or other interested parties may provide user experience, general discussions, or opinions corresponding with the desired items. Potential buyers may discuss their opinions and input regarding trade-offs, comparisons, and benefits between the item listings 1110, 1115 displayed in the offerings field 1105. Any of the buyers, potential buyers, and sellers, for example, may post a link to further information regarding the desired item or the instant discussion relating to the item listings 1110, 1115 or the desired-item listing.

The same summary field 1035 as described above (FIG. 10) may be maintained in the item listing interface 1100 and display similar summary information relating to the buyers' group and the desired-item listing as was available at the time of an initial desired-item search entered by the buyer 130.

After a buyers' group and a corresponding item description are established within the item listing interface 1100, the these summary field 1035 may present statistical or status indicators of the buyers, the sellers, the offerings, and the buyers' group, to name a few possibilities. The summary field 1035 may be used by the online marketplace 105 to display marketing information about buyers, sellers, and offerings so that real-time marketing information is available to the buyers and sellers to make informed decisions about placing a purchase commitment on the part of the buyer, to place a further offering on the part of a further seller, or for the seller of a current offering to review status of buyers, shoppers, total number of items available to the buyers' group, and number of sellers, to name a few possibilities according to some example embodiments.

The summary field 1035 may display quantities and descriptors such as the number of buyers, number of desired-items sought, number of sellers participating in the buyers' group, number of offerings, total number of offered items available in the buyers' group, summary indicator of remaining time to end of a next remaining offering, or number of remaining offerings within a given period of time. Quantities such as these, or further buyer seller and marketplace indicators, may be displayed in the summary field 1035 and retained with the online marketplace 105 to maintain a set of marketing information available for the particular desired-item listing, the present buyers' group, and relating to the marketplace in general.

This marketing information may be available to the buyers, sellers, and the marketplace to keep track of how well a particular buyers' group may have met the needs of buyers and sellers. The set of marketing information may be used to indicate an overall marketing demand for a given desired item as well as the trends in that demand. Trending information may be available to buyers so that they may determine an overall market demand, the total number of items available through the total number of sellers that they may be competing with, and the seller's or further seller's likelihood of positioning a further offering in the buyers' group.

By keeping and managing this type of marketing information across multiple desired-item listings and buyers' group's, the online marketplace 105 may be able to determine and offer informative results as to the lifespan of the typical buyers' interest in a particular type of item. The at least one characteristic of the item description may be used as a key or tag for managing information by item type, model, manufacture, or feature, for example. This type of marketing information may be of such interest to future sellers for instance, that the information may be provided to potential sellers in a further buyers' group for a fee at a later time. An entire marketplace for sets of marketing information may exist at the online marketplace 105 that may be sold to sellers and buyers to aid in their determination of respective interest in selling and purchasing certain types of items.

Certain embodiments are described herein as including logic or a number of components, modules, or mechanism. Modules may constitute either software modules (e.g., code embodied (1) on a non-transitory machine-readable storage medium or (2) in a transmission signal) or hardware-implemented modules. A hardware-implemented module is tangible unit capable of performing certain operations and may be configured or arranged in a certain manner. In example embodiments, one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations for example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments, the processors may be distributed across a number of locations.

The one more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a non-transitory machine-readable storage medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

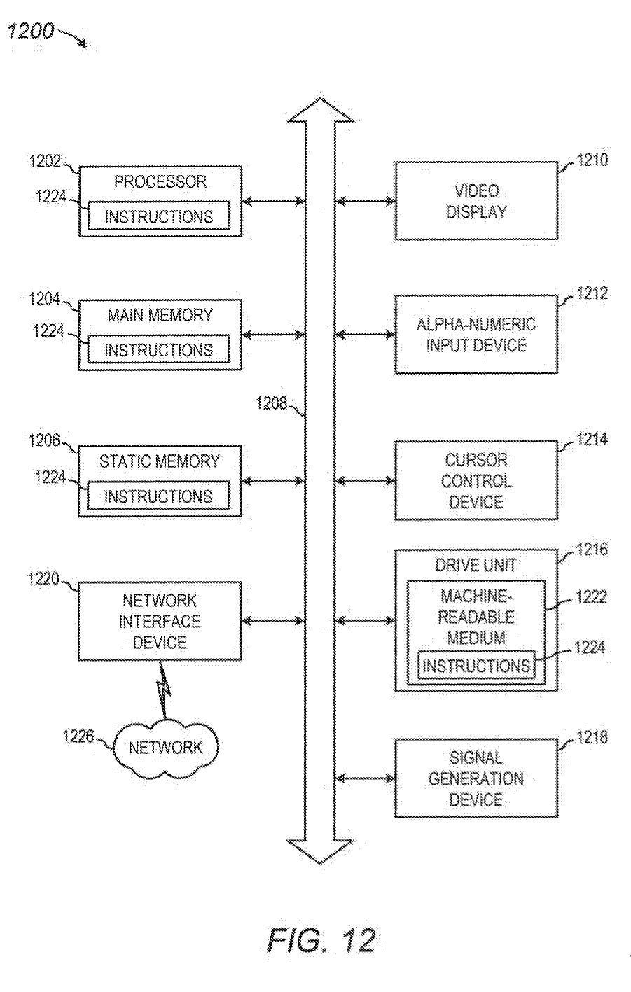

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicates with each other via a bus 1208. The computer system 1200 may further include a video display unit 1210 (e.g., a liquid crystal display (LCD) or a cathode ray rube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

The disk drive unit 1216 includes a non-transitory machine-readable storage medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the non-transitory machine-readable storage medium 1222 is shown in example embodiments to be a single medium, the term “non-transitory machine-readable storage medium” may include a single medium or multiple media (e.g., a centralized or distributed database, and/or associated caches and servers) that store the one or more instructions or data structures. The term “non-transitory machine-readable storage medium” shall also be taken to include any tangible storage medium that is capable of storing, encoding or carrying instructions for execution by the machine and that cause the machine to perform any one or more of the methodologies of the present invention, or that is capable of storing, encoding or carrying data structures utilized by or associated with such instructions. The term “non-transitory machine-readable storage medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefor, is not to be taken in a limiting sense, and the scope of various embodiments is defined only by the appended claims, along with the full range of equivalents to which such claims are entitled.

Such embodiments of the inventive subject matter may be referred to herein, individually and/or collectively by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

Plural instances may be provided for components, operations, or structures described herein as a single instance. Finally, boundaries between various components, operations, and data stores may be somewhat arbitrary, and particular operations may be illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s). One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to various dates attribute values maintained in a database or other memory. p In this document, the terms “a” or “an” are used, as is common in patent documents, to include one or more than one. In this document, the term “or” is used to refer to a nonexclusive or, such that “A or B” includes “A but not B,” “B bin not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, system features, and system mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the invention can be applied to an in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method comprising:
receiving a desired-item description from 1 first device, the desired-item description including at least one characteristic;
forming a desired-item listing corresponding to the desired-item description in an online marketplace;
transmitting the desired-item listing to a corresponding buyers' group;
receiving an item description corresponding to the desired-item listing from a second device;
in response to the receiving the item description, transmitting to the buyers' group an item listing corresponding to the item description and including the at least one characteristic; and
receiving a purchase commitment corresponding to the item listing from the first device.

2. The method of claim 1, further comprising:
in response to the receiving the purchase commitment, incrementing a purchase-commitment count; and
in response to the incrementing, transmitting to the buyers' group, an update to the item listing including the purchase-commitment count,
wherein the buyers' group corresponds to the desired-item description and is communicatively coupled to a computer network associated with the online marketplace.

3. The method of claim 2, further comprising:
from the second device, receiving a purchase-commitment threshold corresponding to the item listing;
in response to the receiving the purchase commitment, incrementing a purchase-commitment count;
determining the purchase-commitment threshold is met when the purchase-commitment count is equal to or greater than the purchase-commitment threshold; and
in response to the determining, transmitting a sale confirmation to the buyers' group.

4. The method of claim 1, further comprising:
from a further device, receiving a further item description corresponding to the desired-item listing and including the at least one characteristic;
creating a further item listing corresponding to the desired-item listing and including the desired-item characteristic;
transmitting the further item listing to the buyers' group.

5. The method of claim 1, further comprising:
transmitting to the buyers' group, a further item listing corresponding to the desired-item listing and including the at least one characteristic;
in response to the transmitting the further item listing, receiving from the first device, a purchase revocation corresponding to the purchase commitment;
decrementing the purchase-commitment count to produce an updated purchase-commitment count; and
transmitting to the buyers' group, an update to the item listing including the updated purchase-commitment count.

6. The method of claim 1, further comprising:
transmitting to the buyers' group, a further item listing corresponding to the desired-item listing and including the at least one characteristic;
receiving from the first device, a further purchase commitment corresponding to the further item listing; and
in response to the receiving the further purchase commitment, incrementing a further purchase-commitment count; and
transmitting to the buyers' group, an update to the further item listing including the further purchase-commitment count.

7. The method of claim 1, further comprising:
in response to receiving the purchase commitment, transmitting to a third device, a funds hold request corresponding to the item listing;
receiving a funds hold confirmation from the third device;
in further response to receiving the purchase commitment, transmitting to a fourth device, shipping data received as a portion of the purchase commitment;
receiving a shipping data confirmation from the fourth device; and
transmitting a purchase commitment confirmation corresponding to the item listing to the first device.

8. The method of claim 1, further comprising:
in response to the receiving the desired-item description, determining that the buyers' group corresponding to the desired-item description and the at least one characteristic does not exist; and
creating the buyers' group including a group characteristic corresponding to the at least one characteristic.

9. The method of claim 1, further comprising:
in response to the receiving the item description, creating the item listing corresponding to the item description and including the at least one characteristic;
wherein the item description includes the at least one characteristic.

10. The method of claim 1, further comprising:
in response to receiving the purchase commitment, determining a purchase-commitment threshold is met;
transmitting a funding activation to a third device;
receiving a funding confirmation from the third device;
transmitting a shipping activation to a fourth device; and
receiving a shipping confirmation from the fourth device;
transmitting a sale confirmation to the buyers' group.

11. A non-transitory machine-readable storage medium comprising instructions, that when implemented by at least one processor, perform the following operations:
receiving a desired-item description from a first device, the desired-item description including at least one characteristic;
forming a desired-item listing corresponding to the desired-item description in an online marketplace;
transmitting the desired-item listing to a corresponding buyers' group;
receiving an item description corresponding to the desired-item listing from a second device;
in response to the receiving the item description, transmitting to the buyers' group an item listing corresponding to the item description and including the at least one characteristic; and
receiving a purchase commitment corresponding to the item listing from the first device.

12. The storage medium of claim 11, further comprising:
from the second device, receiving a purchase-commitment threshold corresponding to the item listing;
in response to the receiving the purchase commitment, incrementing a purchase-commitment count;
in response to the incrementing, transmitting to the buyers' group, an update to the item listing including the purchase-commitment count;
determining the purchase-commitment threshold is met when the purchase-commitment count is equal to or greater than the purchase-commitment threshold; and
in response to the determining, transmitting a sale confirmation to the buyers' group,
wherein the buyers' group corresponds to the desired-item description and is communicatively coupled to a computer network associated with the online marketplace.

13. The storage medium of claim 11, further comprising:
from a further device, receiving a further item description corresponding to the desired-item listing and including the at least one characteristic;
creating a further item listing corresponding to the desired-item listing and including the desired-item characteristic;
transmitting the further item listing to the buyers' group.

14. The storage medium of claim 1, further comprising:
transmitting to the buyers' group, a further item listing corresponding to the desired-item listing and including the at least one characteristic;
in response to the transmitting the further item listing, receiving from the first device, a purchase revocation corresponding to the purchase commitment;
decrementing the purchase-commitment count to produce an updated purchase-commitment count; and
transmitting to the buyers' group, an update to the item listing including the updated purchase-commitment count.

15. The storage medium of claim 11, further comprising:
transmitting to the buyers' group, a further item listing corresponding to the desired-item listing and including the at least one characteristic;
receiving from the first device, a further purchase commitment corresponding to the further item listing; and
in response to the receiving the further purchase commitment incrementing a further purchase-commitment count; and
transmitting to the buyers' group, an update to the further item listing including the further purchase-commitment count.

16. The storage medium of claim 11, further comprising:
in response to receiving the purchase commitment, transmitting to a third device, a funds hold request corresponding to the item listing;
receiving a funds hold confirmation from the third device;
in further response to receiving the purchase commitment, transmitting to a fourth device, shipping data received as a portion of the purchase commitment;
receiving a shipping date confirmation from the fourth device; and
transmitting a purchase commitment confirmation corresponding to the item listing to the first device.

17. The storage medium of claim 11, further comprising:
in response to the receiving the desired-item description, determining that the buyers' group corresponding to the desired-item description and the at least one characteristic does not exist; and
creating the buyers' group including a group characteristic corresponding to the at least one characteristic.

18. The storage medium of claim 11, further comprising:
in response to the receiving the item description, creating the item listing corresponding to the item description and including the at least one characteristic;
wherein the item description includes the at least one characteristic.

19. The storage medium of claim 11, further comprising:
in response to receiving the purchase commitment, determining a purchase-commitment threshold is met;
transmitting a funding actuation to a third device;
receiving a funding confirmation from the third device;
transmitting a shipping activation to a fourth device; and
receiving a shipping confirmation from the fourth device;
transmitting a sale confirmation to the buyers' group.

20. A system comprising:
at least one processor;
a database to receive a description of an item relating to an online marketplace, the database communicatively coupled to the processor;
a group module to determine the existence of a buyers' group and create a buyers+ group when the buyers' group is determined to not exist;
a listing module to produce a listing corresponding to the description of the item;
a confirmation module to maintain metrics relating to receipt of a purchase commitment and a purchase revocation corresponding to the listing produced by the listing module;
an authentication module to authenticate financing and shipping transactions designated by the purchase commitment;
a funding module to secure funding and activate funding corresponding to the purchase commitment; and
a shipping module to provide shipping information and activate shipping of an item relating to the purchase commitment.
